(19) United States
(12) Patent Application Publication
(10) Pub. No.: US 2011/0157098 A1
(43) Pub. Date: Jun. 30, 2011

(54) METHOD AND SYSTEM FOR MAKING NOTES IN ELECTRONIC BOOK VIA ELECTRONIC BOOK READER

(75) Inventor: QING-HUA LIU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/729,421

(22) Filed: Mar. 23, 2010

(30) Foreign Application Priority Data
Dec. 29, 2009 (CN) 200910312619.5

(51) Int. Cl. G06F 3/042

(52) U.S. Cl. 345/176

(57) ABSTRACT

An e-book reader includes a touch screen, a touch screen control module connected to the touch screen, and a note module. The note module includes a transparent window unit and a trace recording unit. The trace recording unit is connected to the touch screen control module to record writing traces written on the touch screen. The transparent window unit includes a transparent window disposed on the touch screen. The writing traces are shown in the transparent window by the transparent window unit.

### BACKGROUND

1. Technical Field

The present disclosure relates to a method and system for adding notes to content in an electronic book using an electronic book reader.

2. Description of Related Art

An electronic book (e-book) is a text file providing the digital media equivalent of a conventional printed book. E-books are usually read on personal computers or smart phones, or on dedicated hardware devices known as e-book readers. An e-book reader is capable of containing many e-books and being more convenient to use than traditional printed books.

Conventional e-book readers provide functions that enable a reader or student to make notes in the pages of the e-books while reading. Different user's notes are usually shown in the e-book readers in the same manner Styles or individual samples of writing can not be represented in the e-book readers.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a system for making notes in an e-book.

FIG. 2 is a flow chart of one embodiment of a method for making notes in an e-book.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

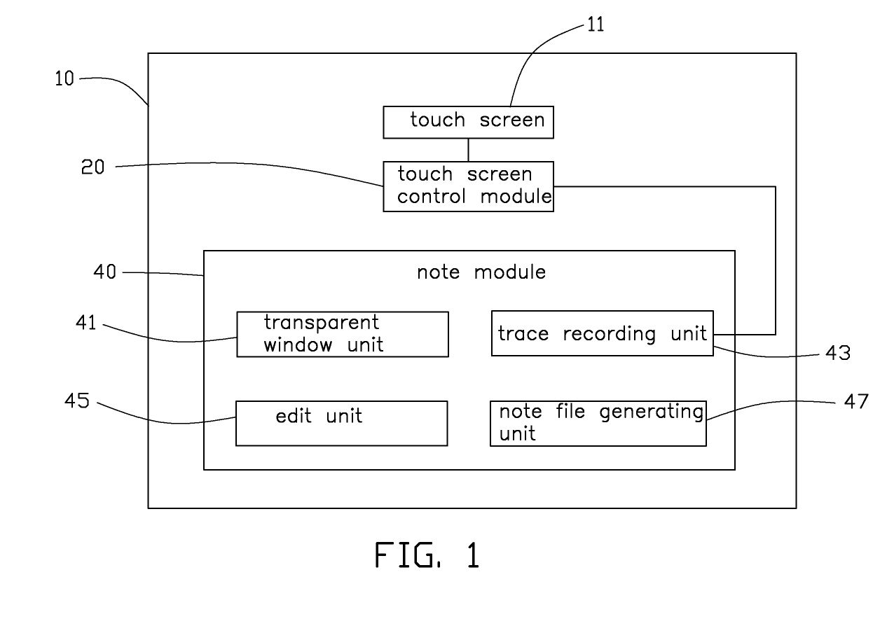

Referring to FIG. 1, an e-book reader 10 is capable of recording notes on e-books. The e-book reader 10 includes a touch screen 11, a touch screen control module 20, and a note module 40. The touch screen control module 20 is connected to the touch screen 11. The note module 40 includes a transparent window unit 41, a trace recording unit 43, an edit unit 45, and a note file generating unit 47.

The transparent window unit 41 generates a transparent window. The transparent window can show notes generated by the note module 40 therein. When an e-book is opened in the e-book reader 10, the transparent window is disposed on the touch screen 11, and the notes are shown in the transparent window. Because the transparent window is transparent, the e-book and the notes can be simultaneously seen in the touch screen 11.

The trace recording unit 43 is connected to the touch screen control module 20. After the transparent window is disposed on the touch screen 11, a user or student can write notes on the touch screen 11. The trace recording unit 43 records the writing traces of the notes.

The edit unit 45 can edit the writing traces shown in the transparent window. For example, the edit unit 45 can change positions of the writing traces in the transparent window, erase selected writing traces, enlarge or reduce the writing traces, or change colors of the writing traces.

The note file generating unit 47 generates a note file based on the writing traces and the corresponding e-book. The note file stores much information, which includes colors of the writing traces, scales of the writing traces, positions of the writing traces in the e-book, and so on. The note file generating unit 47 then transmits the note file to the transparent window unit 41. The transparent window unit 41 shows the writing traces in the transparent window as a note of the e-book based on the note file.

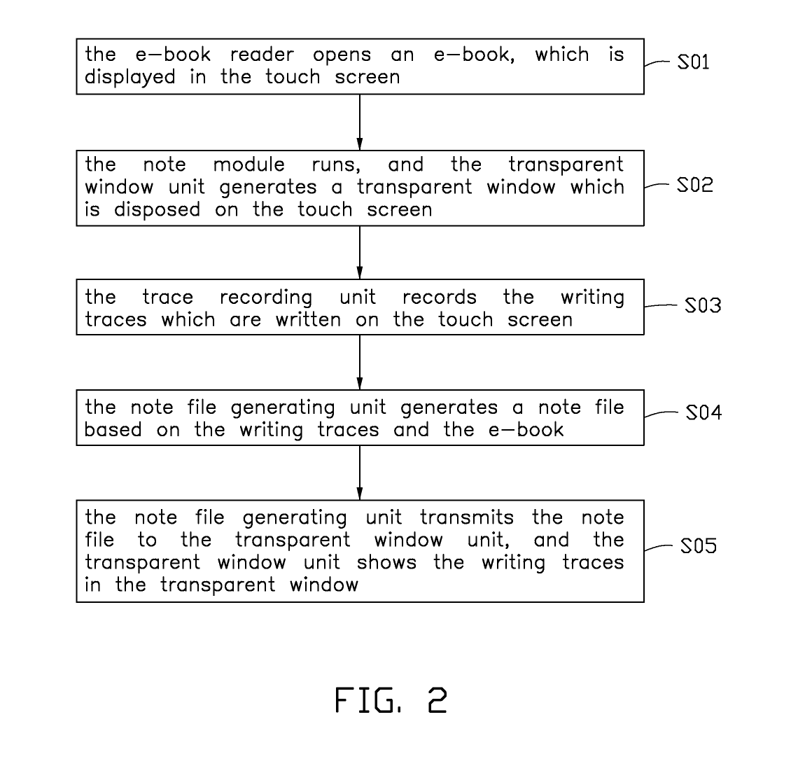

Referring to FIG. 2, a method for taking notes on an e-book is shown, as follows.

In step S01, the e-book reader 10 opens an e-book, which is displayed in the touch screen 11.

In step S02, the note module 40 runs, and the transparent window unit 41 generates a transparent window which is disposed on the touch screen 11.

In step S03, the trace recording unit 43 records the writing traces which are written on the touch screen 11.

In step S04, the note file generating unit 47 generates a note file based on the writing traces and the e-book.

In step S05, the note file generating unit 47 transmits the note file to the transparent window unit 41, and the transparent window unit 41 shows the writing traces in the transparent window.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An e-book reader, comprising:
a touch screen;
a touch screen control module connected to the touch screen; and
a note module comprising a transparent window unit and a trace recording unit, the trace recording unit being connected to the touch screen control module to record writing traces written on the touch screen, the transparent window unit comprising a transparent window disposed on the touch screen, wherein the writing traces are shown in the transparent window by the transparent window unit.

2. The e-book reader of claim 1, wherein the note module comprises an edit unit which edits the writing traces shown in the transparent window.

3. The e-book reader of claim 2, wherein the edit unit also changes positions of the writing traces in the transparent window.

4. The e-book reader of claim 2, wherein the edit unit also erases unneeded writing traces.

5. The e-book reader of claim 2, wherein the edit unit also enlarges or reduces the writing traces.

6. The e-book reader of claim 2, wherein the edit unit also changes colors of the writing traces.

7. The e-book reader of claim 1, wherein the note module comprises a note file generating unit, which generates a note file based on the writing traces and the e-book.

8. The e-book reader of claim 7, wherein the note file stores at least one information of colors of the writing traces, scales of the writing traces, and positions of the writing traces in the e-book.

9. A method for making note in an e-book, comprising:
providing an e-book reader comprising a touch screen, and a note module comprising a transparent window unit and a trace recording unit;
opening the e-book by the e-book reader, and displaying the e-book on the touch screen of the e-book reader;
generating a transparent window on the touch screen by the transparent window unit of the note module;
writing traces of notes on the touch screen, and recording the written traces by the trace recording unit of the note module; and
displaying the writing trace in the transparent window.

10. The method of claim 9, further comprising generating a note file based on the writing traces and the e-book.

11. The method of claim 10, further comprising transmitting the note file to the transparent window unit, and displaying the writing trace in the transparent window based on the note file, by the transparent window unit.

12. The method of claim 10, further comprising storing at least one information of colors of the writing traces, scales of the writing traces, and positions of the writing traces in the e-book, in the note file.
